(19) United States
(12) Patent Application Publication
(10) Pub. No.: US 2006/0206419 A1
(43) Pub. Date: Sep. 14, 2006

(54) Business process and user interfaces for money transfer

(76) Inventors: Peter Rosti, Beverly Hills, CA (US); David Firshein, Fairfax, CA (US); Uli Zangpo, Forest Knolls, CA (US)

Correspondence Address: SAWYER LAW GROUP LLP, P O BOX 51418, PALO ALTO, CA, 94303, US

(21) Appl. No.: 11/078,859

(22) Filed: Mar. 10, 2005

(51) Int. Cl. G06Q 40/00

(52) U.S. Cl. 705/39

(57) ABSTRACT

The present invention is a control system and set of methods for providing and controlling a money payment transaction through a network. The methods comprise determining the values of several variables which influence the fee charged for the transaction by choices from an array of selections, and then charging a predetermined fee for the transaction based on the determined values of the selected variables. Alternatively, the methods comprise selecting a fee, and determining the allowable timing parameters for such a fee. Guarantees for settlement of the transaction within certain timing constraints are also provided. The benefits of this system and methods are that Users, instead of financial intermediaries such as banks or other transaction processors, can explicitly control the timing of a money payment transaction.

### FIELD OF THE INVENTION

The field of the invention is the payments business, also known as the money transfer business, wherein money belonging to one party is transferred or paid to another party.

### BACKGROUND OF THE INVENTION

Individuals or business entities commonly maintain bank accounts and other funds storage accounts in banks and other financial institutions. Control of these accounts, and the instructions for crediting or debiting funds is commonly achieved through a wide variety of interfaces, including teller operations, Automated Teller Machines (ATMs), and online interfaces such as through Web sites. Transfer of money from one account to another typically occurs by means of one party (the payor) instructing his financial institution to pay or transfer funds to another party (the payee) or to the payee's account. Such instructions may be by means of paper instruments, such as checks (demand notes), or through various electronic means. Depending on many factors, the availability of funds for the discretionary use of the payee may be immediate, but is commonly delayed some varying time (the “float time”, or “float”). This delay is a consequence of a variety of factors, including processing delays, and credit risk.

The most important cause of payment delay is the credit risk associated with the payor's available cash balance at the time the payment is settled at the payee's bank. The problem is rooted in traditional payment processing methods used by banks, wherein many transactions involving many unrelated parties are batched together and settled as a group, all on a daily schedule, typically overnight. A payment initiated by a payor, for which sufficient funds are available at the time of initiation, may or may not have sufficient funds available for payment at the time of settlement. Thus additional checks and balances are required to verify the payor's funds. These processes introduce delays into the settlement of each individual payment, and historically led to the rise of long float times.

Complete settlement of an individual transaction is relatively inefficient from an operational standpoint, hence expensive. Until recently, in most banking systems, immediate settlement of common transactions has not been commercially feasible. Thus the first motivation for use of float is to ensure that funds are really available for transfer at the time of settlement, and that all supporting documentation is available and correct, and located in the right place. Providing funds to a payee before actual settlement can lead to losses to the issuing bank.

Financial institutions have a second motivation for use of float, however: profit from early clearing of funds. As electronic means of transferring funds and providing settlement services have evolved, they have enabled financial institutions to settle transactions faster than before, and withhold cleared (settled) funds from payees for some part of the administratively declared float time. During the time that funds have already been cleared, but have not yet been payed out to the payee, the financial institution can obtain interest on the funds by lending them out to other financial institutions. So-called overnight lending and other lending practices between financial institutions enables them to derive significant profits from delayed release of funds to payees.

Specialized systems have been designed to provide faster clearing of transactions, such as private networks, like the one used by Western Union. Users typically pay fees on the order of ten to twenty-five percent surcharge to achieve rapid clearing, within a single financial institution.

The development of Automated Clearing House (ACH) operations provided faster clearing of transactions through electronic means, as well as providing additional conveniences for the US government and other entities. ACH is used in so-called “direct deposit” payments, for payroll operations and other automated payment operations. The ACH system enables financial institutions to clear funds much faster and with much greater control than previously possible. But financial institutions have been slow to transfer the benefits of such systems to commercial or individual end users of such systems (payors and payees). As of year 2005, the development and implementation of software to handle fast or immediate clearing of funds in general commercial banking operations is underway, but it is being developed slowly. Within a few years, at most, financial institutions will be able to clear and settle most funds on a per-transaction basis at very low cost.

Electronic funds transfer networks (EFTs) are already in use in the U.S. and world-wide to move money and make payments very quickly. Some of these networks are able to move the electronic representation of a transaction on a near-real-time or real-time basis (essentially immediately). The application of the use of these payment networks for the direct use and benefit of individuals and businesses is now beginning to be effected.

So in principle, for most end-users, funds transfers are either slow, or expensive. Either way, the float used by the financial institutions is not within the control of either the payor or the payee, except in a very crude way.

### SUMMARY OF THE INVENTION

The present invention is a control system and set of methods for providing and controlling a money payment transaction through a network. The methods comprise determining the values of several variables which influence the fee charged for the transaction by choices from an array of selections, and then charging a predetermined fee for the transaction based on the determined values of the selected variables. Alternatively, the methods comprise selecting a fee, and determining the allowable timing parameters for such a fee. Guarantees for settlement of the transaction within certain timing constraints are also provided.

The benefits of this system and methods are that Users, instead of financial intermediaries such as banks or other transaction processors, can explicitly control the timing of a money payment transaction.

### BRIEF DESCRIPTION OF THE DRAWINGS

Key of Numerals for the Figures

201: Contextual background of the user interface page

203: Buttons, clickable regions, or slider controls

205: Data entry areas

207: Calculated fields and replies to user entry

FIG. 1—Transaction Sequence

Transaction sequence logic flow given from the viewpoints of the Payor and Payee.

FIG. 2—Transaction Interface Screen (Payor's Input Page)

Settlement time selected, fee-returned logic.

FIG. 3—Transaction Interface Screen (Payor's Input Page)

A variant of the format of FIG. 2, settlement time selected, fee-returned logic.

FIG. 4—Transaction Interface Screen (Payor's Input Page)

Another variant of the format of FIG. 2, settlement time selected, fee-returned logic.

FIG. 5—Transaction Interface Screen (Payor's Input Page)

Fee selected, settlement time returned logic.

FIG. 6—Transaction Interface Screen (Payor's Input Page)

Settlement time subject to a guarantee selected, fee returned with guarantee logic.

FIG. 7—Transaction Interface Screen (Payor's Input Page)

Settlement time selected subject to a probabilistic guarantee, fee returned with probabilistic guarantee logic.

### DETAILED DESCRIPTION OF THE INVENTION

The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiments shown but is to be accorded the widest scope consistent with the principles and features described herein.

Process Logic of the System

There are four principal parties to a money transfer: They are:

1) Payor;

2) Payor's financial institution (Payor's Bank), which holds Payor's money;

3) Payee's financial institution (Payee's Bank), which can hold Payee's money; and

4) Payee.

In some implementations, parties 2) and 3) may be the same entity.

There is also a broad spectrum of roles typically played by software in the modern banking system. We will here define one additional specific role that may be handled by the Payor's Bank, or the Payee's Bank, or broken out and controlled by a fifth entity. The role is that of the Transaction Processor. For convenience of description only, we will call the fifth entity itself the Transaction Processor, and consider it separate and distinct from the others.

Outside the context of this invention, in a typical money transfer, Payor instructs Payor's Bank to transfer Payor's money held in Payor's account to Payee's Bank. Payor's Bank verifies availability of funds, and then transfers money to Payee's account in Payee's Bank. Payee's Bank makes these funds available to Payee, typically after some delay (float). Alternatively, such as in the process used by Western Union, Payor gives money (typically cash) to the Transaction Processor directly, which then makes an accounting entry in its private network, after which the Payee can withdraw the finds in another operating location of the Transaction Processor, and the Transaction Processor makes the corrsponding accounting entry noting the payment on its system.

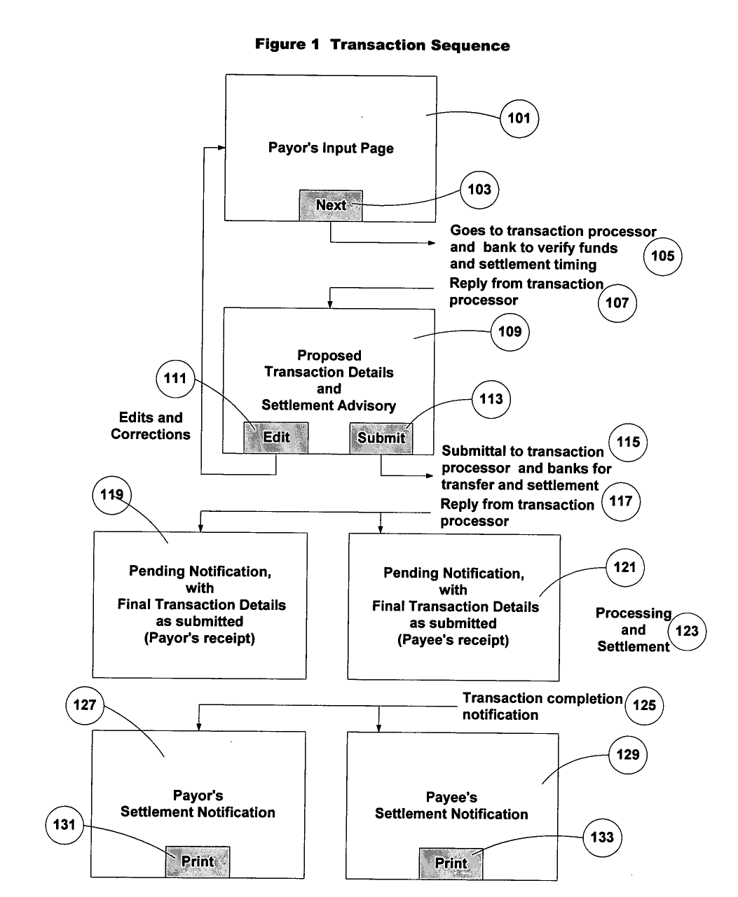

This invention modifies this process in several significant respects, by adding several steps, which efectively transfer control of the timing of the transaction to the Users (Payor or Payee, or both). Refer to the numbered Steps (e.g. “101”) in FIG. 1. The interface through which the display appears can be any machine diplay system, such as a computer screen, cell phone display, or other electronic display. Alternatively, the Users can operate the system remotely by means of a telephone discussion with a live person representing the user interface, or by means of a telephone discussion or telephone keypad input to a voice-recognition or machine reading system. In such latter cases, the Pages represented in the Figures are meant to describe the data capture mechanism of the system.

1) Through the Payor's Input Page (101), the Payor proposes a money transfer, with specific transaction timing (float) criteria and/or guarantee criteria. The details of the selection choices of these criteria constitute key features of this system, as considered in greater detail below.

2) By clicking “Next” (103) the proposed transaction is sent to the Transaction Processor, which assesses it against available float parameters (such as may be contained in an internal database), or sends it to Payor's and Payee's banks for confirmation, and sends the proposed transaction to the Payor's bank for verification of funds, (collectively 105).

3) Upon completion of the assessment of the transaction by the Transaction Processor and/or the corresponding banks, a confirmation (or denial) of the transaction is sent to the Payor (107). If the transaction cannot proceed as originally requested by the Payor, but a similar transaction with modifications could in fact proceed, a proposal for such a modified transaction candidate may be sent back for consideration by the Payor, (109).

4) The Payor may edit (111) the proposed transaction and resubmit it (103).

5) Upon confirmation of the proposed transaction, either in its original form or in the modified form, by clicking “Next” (113) the Payor submits the transaction to the Transaction Processor for processing.

6) The Transaction Processor in turn submits the transaction to the corresponding banks and transaction processing intermediaries for processing (115).

7) Upon receipt of the submittal (117), the Payor and/or the Payee is/are sent a confirmation of the submittal (119, 121), and the transaction is considered to be in a pending status.

8) The transaction is made between the Payor's Bank and the Payee's Bank through available banking processes, optionally including classical mechanisms, ACH transfer mechanisms, EFT mechanisms, etc., (123). The Transaction Processor selects the process most suitable for the timing requirements of the proposed transaction.

8) Upon settlement, the Payee's Bank notifies the Transaction Processor of settlement and availability of funds to the Payee (125).

9) The Transaction Processor in turn notifies the Payor and/or the Payee of the settlement of the transaction (127,129).

10) The Payee may leave the funds in his bank account or collect the funds in hand through any usual means, such as through bank teller operations, or through an Automatic Teller Machine (ATM).

Input Process Logic

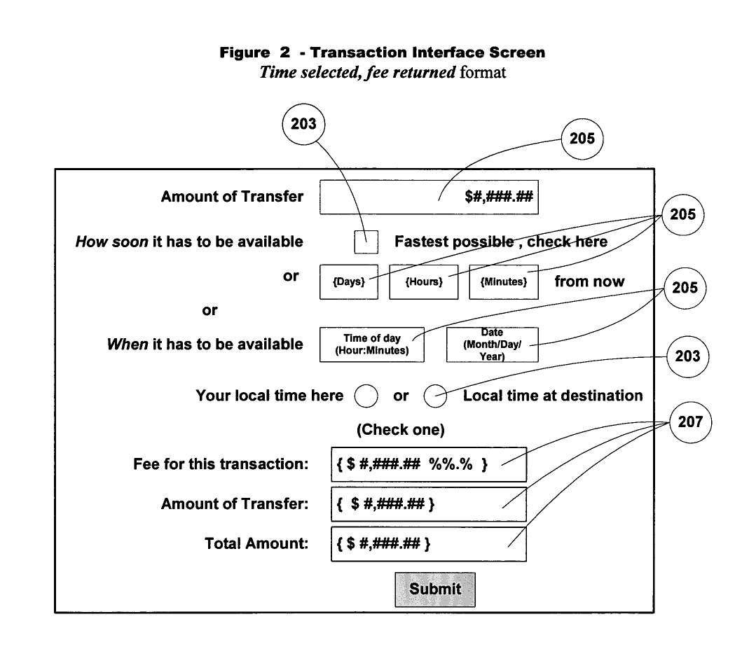

FIGS. 2 through 7 illustrate various user interfaces, which embody various methods of determining the values of input parameters, and resulting transaction processing conditions and fees.

FIG. 2 illustrates the business process control logic in which the User selects (203, 205) either how soon the transaction must be completed (in elapsed time), or when the transaction must be completed (in calendar time), and the system returns (207) the amount of the fee. Selection is by filling values into input boxes (203, 205).

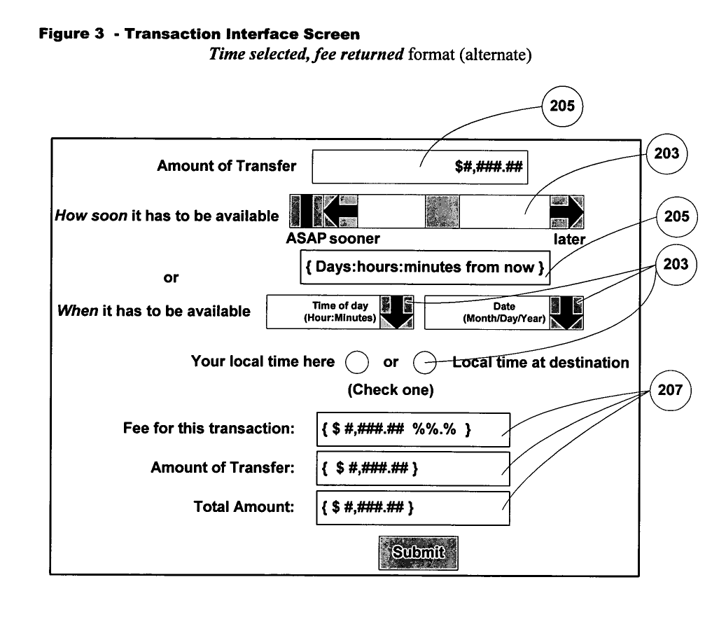

FIG. 3 illustrates a variation of the interface shown in FIG. 2. User selects (203, 205) either how soon the transaction must be completed (in elapsed time), or when the transaction must be completed (in calendar time), and the system returns (207) the amount of the fee. Selection of transaction amount is by filling value into input box (205); time selection is by means of a slider bar (203) which depicts a transaction occurring sooner or later, with the system returning the speed of the transaction as text (207); or selection is by means of drop-down selection values specifying when the transaction must be completed in calendar time (203). The system reports (207) the fee for this transaction.

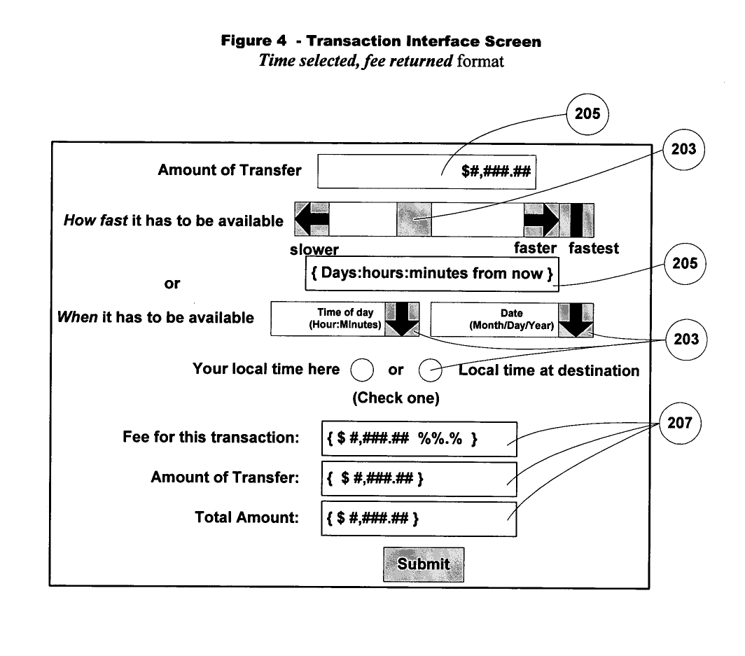

FIG. 4 illustrates another variation of the interface shown in FIG. 2. User selects (203, 205) either how fast the transaction must be completed (in elapsed time), or when the transaction must be completed (in calendar time), and the system returns (207) the amount of the fee. Selection of transaction amount is by filling value into input box (205); time selection is by means of a slider bar (203) which depicts a transaction occurring faster or slower, with the system returning the speed of the transaction as text (207); or selection is by means of drop-down selection values (203) specifying when the transaction must be completed in calendar time. The system reports (207) the fee for this transaction.

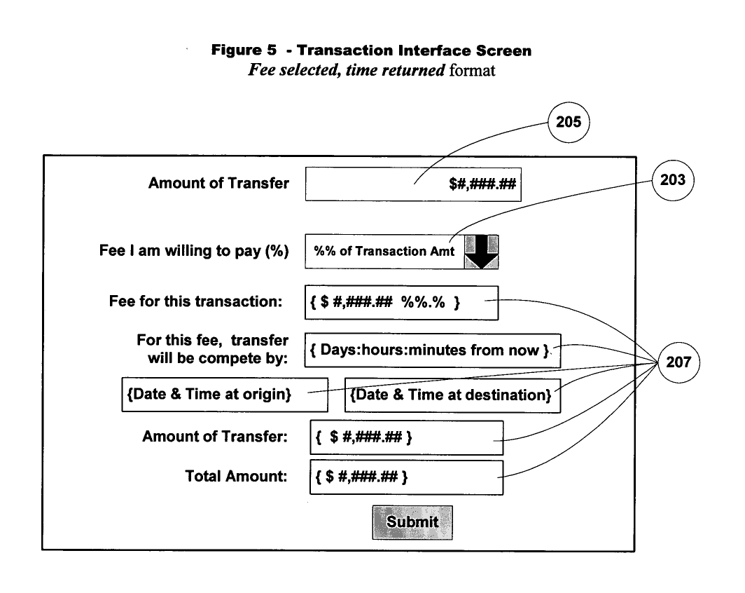

FIG. 5 illustrates an interface where the User selects (203, 205) an acceptable fee for the transaction, expressed as a percentage of the transaction amount. The system returns (207) fee amount expressed in dollars, as well as the time for the transaction, expressed as how soon the transaction can be completed (in elapsed time), and when the transaction can be completed (in calendar time). Selection of transaction amount is by filling value into input box (205); fee selection is by means of a drop-down box (203) containing selection values specifying possible fees.

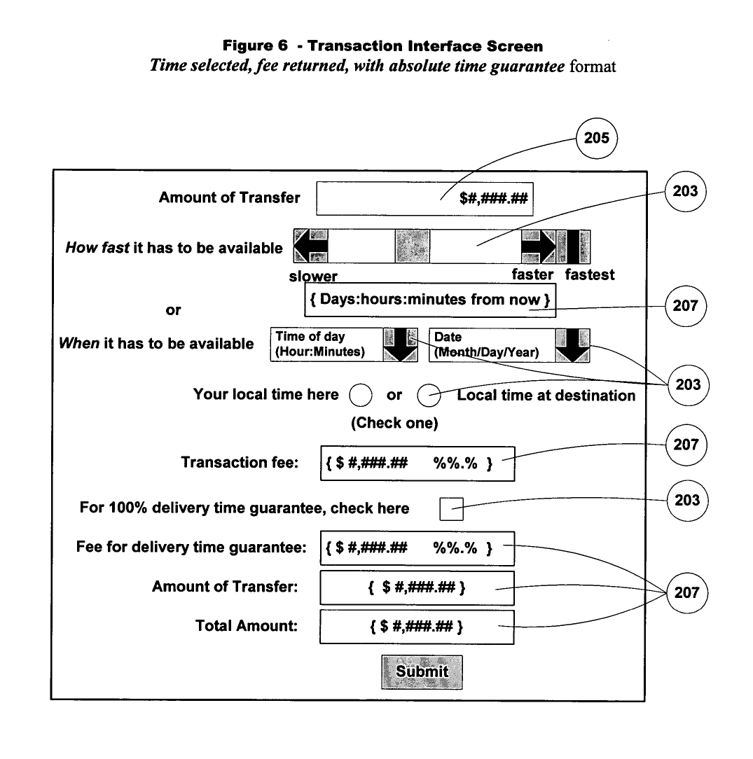

FIG. 6 illustrates an interface wherein the User selects (203, 205) either how soon the transaction must be completed (in elapsed time), or when the transaction must be completed (in calendar time), and the system returns (207) the amount of the fee. Selection of transaction amount is by filling value into input box (205); time selection is by means of a slider bar (203) which depicts a transaction occurring faster or slower, with the system returning (207) the speed of the transaction as text; or selection is by means of drop-down selection values (203) specifying when the transaction must be completed in calendar time. The system reports (207) the fee for this transaction. The user may select to receive a time-of-completion (settlement) guarantee for an additional fee, by marking a check box (203). The system returns (207) the fee for the guarantee.

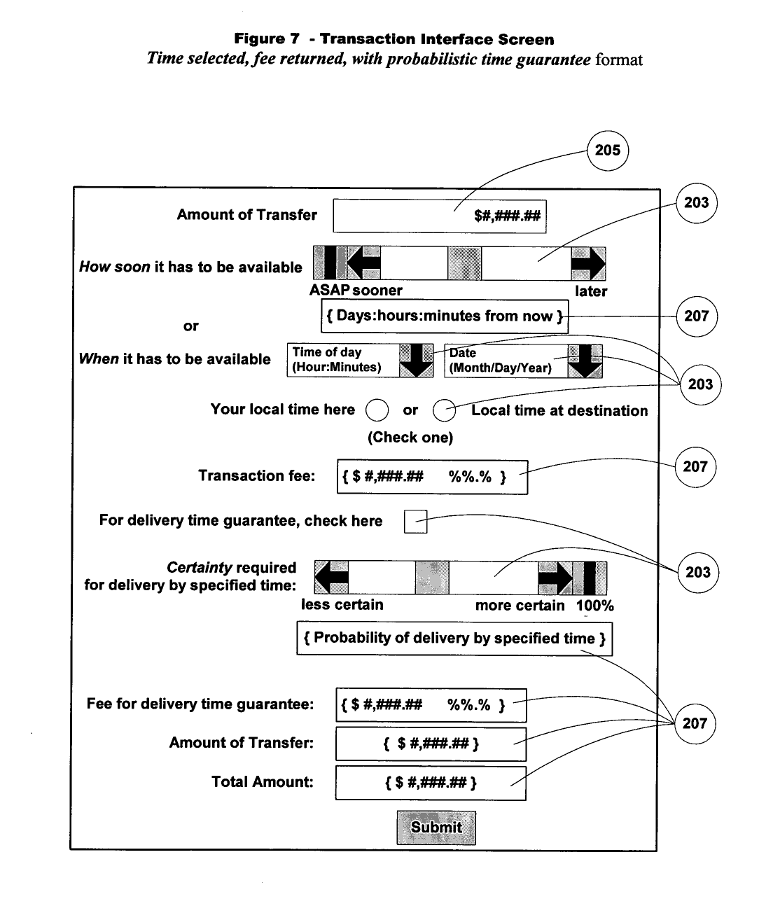

FIG. 7 illustrates an interface wherein the use of probabilistic estimates of the likelihood of settlement of the transaction, and corresponding guarantees are controlled.

This is a variation of the format shown in FIG. 6. User selects (203, 205) either how soon the transaction must be completed (in elapsed time), or when the transaction must be completed (in calendar time), and the system returns (207) the amount of the fee. Selection of transaction amount is by filling value into input box (205); time selection is by means of a slider bar (203) which depicts a transaction occurring faster or slower, with the system returning (207) the speed of the transaction as text; or selection is by means of drop-down selection values (203) specifying when the transaction must be completed in calendar time. The system reports (207) the fee for this transaction. The user may select to receive a probabilistic time-of-completion (settlement) guarantee for an additional fee, by setting a slider bar (203) to request a level of certainty for the transaction within the required time. The system returns (207) the fee for the probabilistic guarantee.

Required Additional Components

Additional components are required for the functional completion of complete money transfer (transaction) processing system. The system which is described herein is intended to operate as a subsystem of complete money transfer (transaction) processing system. Accordingly, this invention does not address these additional components. It refers to these additional processing components only from the viewpoint of passing data out of and into the process components that are material to the invention itself. Thus, for example, the mechanisms whereby banks move funds, clear funds and verify settlement, etc., are not addressed.

The user interfaces through which the Payor (and/or the Payee) conduct(s) the transaction are directly material to, and are components of, this system. However, additional supporting components are required in this context as well, but these supporting components, considered individually, are not unique to this invention. The combination of the primary components with these supporting components is unique to this invention. The supporting components required, for example, in a Payor's Input Page may include Payor's Name, Name of Payor's Bank (or other financial institution), Routing Number of Payor's financial institution, Payor's Account Number, Payee's Name, Name of Payee's Bank (or other financial institution), Routing Number for Payee's financial institution, Payee's Account Number, a unique Transaction Number, a Transaction Date and Time Stamp, and a digital signature of the Payor.

For convenience of description of the primary components of the invention, these supporting components are omitted, but are understood to be required for the complete transaction processing system to function properly.

Example Embodiment of the Invention #1

In this embodiment, the Transaction Processor is an independent entity as described above. Thus the primary entities are the Payor, the Payee, the Payor's Bank, the Payee's Bank, and the Transaction Processor.

The Transaction Processor is comprised of three key elements:

a) A web site, by means of which Payor and Payee have access to the transaction process;

b) Processing software, by means of which transaction requests are processed, and queries and replies are sent from Payor and/or Payee to Payor's Bank and/or Payee's Bank from Payor's Bank and/or Payee's Bank to Payor and/or Payee, and/or Transaction Processor.

c) An internal database that holds business processing rules, float capabilities of correspondent financial institutions, and transaction records.

The Payor may “go to” the Transaction Processor's web site (actually, obtain an Input Page from the web server), and interact with the Transaction Processor through the Input Page.

The Transaction Processor services the input from the Payor and/or Payee, and sends replies back to the Payor and/or Payee through the same means.

The Input Page(s) is/are in accordance with one or more of the variations described in FIGS. 2 through 7.

Example Embodiment of the Invention #2

This implementation is like Implementation #1, except that the Transaction Processor is one of either the Payor's financial institution (typically a bank) or the Payee's financial institution (also typically a bank). In its role as Transaction Processor, the financial institution maintains the business processing logic and related database as described above internally, or may outsource these services, obtaining some or all of the services from another entity.

The transaction Input Page and other Pages are accessible to the Payor and/or Payee through the financial institution's own web site. The features of the transaction process may be explicitly provided as shown in FIGS. 2 through 7, or may be adapted and integrated into the bank's own interface, while providing the business process logic as described above.

The web interface may be accessible through a computer, or mobile device such as a Personal Digital Assistant (PDA), or hybrid PDA/cell phone.

Example Embodiment of the Invention #3

This implementation is like Implementation #2, except that the Input Page interface is designed to be accessible through an Automatic Teller Machine.

Example Embodiment of the Invention #4

This implementation is like Implementation #1 or #2, except that the Input Page interface is not visible to the Users, but rather the input data is entered on a telephone keypad or other typed-input keypad, in response to audio instructions provided through a telephone. These instructions can be through a simple recorded-response audio system (uni-directional), or through a bi-directional voice-response system, or by means of a telephone conversation with a live individual person who is entering the data into the system on behalf of a User.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A method for providing and controlling a money transaction through a network, the method comprising:
a) determining the values of several variables which influence the fee charged for the transaction by choices from an array of selections; and
b) charging a predetermined fee for the transaction based on the determined values of the selected variables.

2. A method for providing and controlling a money transaction through a network, the method comprising:
a) determining a possible fee for the transaction; and
b) setting the values of several variables which depend on the determined fee charged for the transaction.

3. The method of claim 1, in which the value determining step a) comprises:
a1) determining the desired speed of the transaction.

4. The method of claim 1, in which the value determining step a) comprises:
a1) determining the desired elapsed time of the transaction.

5. The method of claim 1, in which the value determining step a) comprises:
a1) determining the desired future date and time of settlement of the transaction.

6. The method of claim 2, in which the value set in step b) comprises:
b1) the speed of the transaction.

7. The method of claim 2, in which the value set in step b) comprises:
b1) the elapsed time of the transaction.

8. The method of claim 2, in which the value set in step b) comprises:
b1) the future date and time of settlement of the transaction.

9. A method for providing and controlling a money transaction through a network, the method comprising:
a) determining the timing parameters of the transaction and the corresponding fee for the transaction by selection from a multi-dimensional array of choices.

10. A method for providing and controlling a money transaction through a network, the method comprising:
a) determining the values of several timing variables which influence the fee charged for the transaction by choices from an array of selections;
b) providing a corresponding probabilistic estimate of the likelihood of settlement of the transaction corresponding to the determined timing values of the variables of step a);
c) providing a probabilistic guarantee of settlement of the transaction corresponding to the determined timing values of the variables of step a); and
d) setting the fee for the transaction based on the determined timing and probabilistic likelihood of settlement of the transaction corresponding to the determined timing values of the variables of step a) and corresponding to the set probabilistic estimate of step b), and corresponding to the set probabilistic guarantee of step c).

11. The method of claim 10, in which the value determining step a) comprises:
a1) determining the desired speed of the transaction.

12. The method of claim 10, in which the value determining step a) comprises:
a1) determining the desired elapsed time of the transaction.

13. The method of claim 10, in which the value determining step a) comprises:
a1) determining the desired future date and time of settlement of the transaction.

14. A method for providing and controlling a money transaction through a network, the method comprising:
a) determining a possible fee for the transaction;
b) providing a corresponding probabilistic estimate of the likelihood of settlement of the transaction corresponding to the determined fee of step a);
c) providing a probabilistic guarantee of settlement of the transaction corresponding to the determined fee of step a); and
d) setting the values of several timing variables.

15. The method of claim 14, in which the value set in step d) comprises:
d1) setting the speed of the transaction.

16. The method of claim 14, in which the value set in step d) comprises:
d1) setting the elapsed time of the transaction.

17. The method of claim 14, in which the value set in step d) comprises:
d1) setting the future date and time of settlement of the transaction.

18. A system for providing and controlling a money transaction through a network, comprising:
a user interface containing a mechanism for determining the values of several variables which influence the fee charged for the transaction by choices from an array of selections, and a mechanism for displaying the value of a predetermined fee for the transaction based on the determined values of the selected variables;
a set of program instructions for evaluating user input and setting the values of variables in response to user input, and for passing messages to other systems in which this system may be embedded; and
a database containing stored values of transaction-related variables.

19. The system of claim 18 in which the user interface contains a mechanism for determining the desired speed of a transaction from user input.

20. The system of claim 18 in which the user interface contains a mechanism for determining the desired elapsed time of a transaction from user input.

21. The system of claim 18 in which the user interface contains a mechanism for determining the future time and date of a transaction from user input.

22. A system for providing and controlling a money transaction through a network, comprising:
a user interface containing a mechanism for determining a possible fee for the transaction, and a mechanism for displaying the values of several variables which depend on the determined fee charged for the transaction;
a set of program instructions for evaluating user input and setting the values of variables in response to user input, and for passing messages to other systems in which this system may be embedded; and
a database containing stored values of transaction-related variables.

23. The system of claim 22 in which the user interface contains a mechanism for setting the speed of the transaction.

24. The system of claim 22 in which the user interface contains a mechanism for setting the elapsed time of the transaction.

25. The system of claim 22 in which the user interface contains a mechanism for setting the future date and time of the transaction.

26. A system for providing and controlling a money transaction through a network, comprising:
a user interface containing a mechanism for determining the timing parameters of the transaction and the corresponding fee for the transaction by selection from a multi-dimensional array of choices;
a set of program instructions for evaluating user input and setting the values of variables in response to user input, and for passing messages to other systems in which this system may be embedded; and
a database containing stored values of transaction-related variables.

27. A system for providing and controlling a money transaction through a network, comprising:
a user interface containing a mechanism for determining the values of several variables which influence the fee charged for the transaction by choices from an array of selections, and a mechanism for providing a corresponding probabilistic estimate of the likelihood of settlement of the transaction corresponding to the determined values of the timing variables, a mechanism for providing a probabilistic guarantee of settlement of the transaction corresponding to the determinedvalues of the timing variables, and a mechanism for displaying the value of a predetermined fee for the transaction based on the determined values of the selected variables;
a set of program instructions for evaluating user input and setting the values of variables in response to user input, and for passing messages to other systems in which this system may be embedded; and
a database containing stored values of transaction-related variables.

28. The system of claim 27 in which the user interface contains a mechanism for determining the desired speed of a transaction from user input.

29. The system of claim 27 in which in which the user interface contains a mechanism for determining the elapsed time of a transaction from user input.

30. The system of claim 27 in which the user interface contains a mechanism for determining the future date and time of a transaction from user input.

31. A system for providing and controlling a money transaction through a network, comprising:
a user interface containing a mechanism for determining a possible fee for the transaction, a mechanism for providing a corresponding probabilistic estimate of the likelihood of settlement of the transaction corresponding to the determined values of the timing variables, a mechanism for providing a probabilistic guarantee of settlement of the transaction corresponding to the determined values of the timing variables, and a mechanism for displaying the value of the values of several variables which depend on the determined fee charged for the transaction;
a set of program instructions for evaluating user input and setting the values of variables in response to user input, and for passing messages to other systems in which this system may be embedded; and
a database containing stored values of transaction-related variables.

32. The system of claim 31 in which the user interface contains a mechanism for setting the speed of the transaction.

33. The system of claim 31 in which the user interface contains a mechanism for setting the elapsed time of the transaction.

34. The system of claim 31 in which the user interface contains a mechanism for setting the future date and time of the transaction.

35. A computer-readable medium containing a set of program instructions for providing and controlling a money transaction through a network, comprising:
a) determining the values of several variables which influence the fee charged for the transaction by choices from an array of selections; and
b) charging a predetermined fee for the transaction based on the determined values of the selected variables.

36. A computer-readable medium containing a set of program instructions for providing and controlling a money transaction through a network, comprising:
a) determining a possible fee for the transaction; and
b) setting the values of several variables which depend on the determined fee charged for the transaction.

37. A computer-readable medium containing a set of program instructions for providing and controlling a money transaction through a network, comprising:
a) determining the timing parameters of the transaction and the corresponding fee for the transaction by selection from a multi-dimensional array of choices.

38. A computer-readable medium containing a set of program instructions for providing and controlling a money transaction through a network, comprising:
a) determining the values of several timing variables which influence the fee charged for the transaction by choices from an array of selections;
b) providing a corresponding probabilistic estimate of the likelihood of settlement of the transaction corresponding to the determined timing values of the variables of step a);
c) providing a probabilistic guarantee of settlement of the transaction corresponding to the determined timing values of the variables of step a); and
d) setting the fee for the transaction based on the determined timing and probabilistic likelihood of settlement of the transaction corresponding to the determined timing values of the variables of step a) and corresponding to the set probabilistic estimate of step b), and corresponding to the set probabilistic guarantee of step c).

39. A computer-readable medium containing a set of program instructions for providing and controlling a money transaction through a network, comprising:
a) determining a possible fee for the transaction;
b) providing a corresponding probabilistic estimate of the likelihood of settlement of the transaction corresponding to the determined fee of step a);
c) providing a probabilistic guarantee of settlement of the transaction corresponding to the determined fee of step a); and
d) setting the values of several timing variables.
